(19) United States
(12) Patent Application Publication
(10) Pub. No.: US 2024/0140270 A1
(43) Pub. Date: May 2, 2024

(54) VOLTAGE BALANCING CIRCUIT AND CONTROLLER FOR SAME

(71) Applicant: Lear Corporation, Southfield, MI (US)

(72) Inventors: Hector SARNAGO ANDIA, Olvega (Soria) (ES); Oscar LUCIA GIL, Zaragoza (ES); Ruben MOLINA LLORENTE, Reus (ES); Antonio MARTINEZ PEREZ, Tarragona (ES); Pablo GAONA ROSANES, Sarreal (ES); Rafael JIMENEZ PINO, Valls (ES)

(73) Assignee: Lear Corporation, Southfield, MI (US)

(21) Appl. No.: 18/477,741

(22) Filed: Sep. 29, 2023

Related U.S. Application Data
(60) Provisional application No. 63/381,623, filed on Oct. 31, 2022.

(51) Int. Cl. B60L 58/22; B60L 58/21

(52) U.S. Cl. CPC B60L 58/22; B60L 58/21; B60L 2210/10; B60L 2240/547

(57) ABSTRACT

A voltage balancing circuit includes a direct-current-to-direct-current (DC-to-DC) voltage converter interconnecting a first battery having a first voltage and a second battery having a second voltage, wherein the DC-to-DC converter transfers electrical power from the first battery to the second battery when the first voltage is greater than the second voltage, and transfers electrical power from the second battery to the first battery when the first voltage is less than the second voltage, and wherein the transfer of electrical power from the first battery to the second battery or from the second battery to the first battery balances the electrical power difference between the first battery and the second battery.

### CROSS-REFERENCE TO RELATED APPLICATION

This application claims the benefit of U.S. Provisional Application Ser. No. 63/381,623 filed on Oct. 31, 2022, the disclosure of which is hereby incorporated by reference herein in its entirety.

### TECHNICAL FIELD

The present disclosure relates to a voltage balancing circuit and a controller for the same.

### BRIEF DESCRIPTION OF THE DRAWINGS

FIG. 1 is a simplified block diagram of a non-limiting, exemplary embodiment of an electric or hybrid electric vehicle;

FIG. 2 is a simplified block diagram of a non-limiting, exemplary embodiment of an electric or hybrid electric vehicle equipped with a voltage balancing circuit according to the present disclosure;

FIG. 3 is a simplified block diagram of a non-limiting, exemplary embodiment of a voltage balancing circuit according to the present disclosure; and

FIG. 4 is an operation map of a non-limiting, exemplary embodiment of a voltage balancing circuit according to the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, features, and elements have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

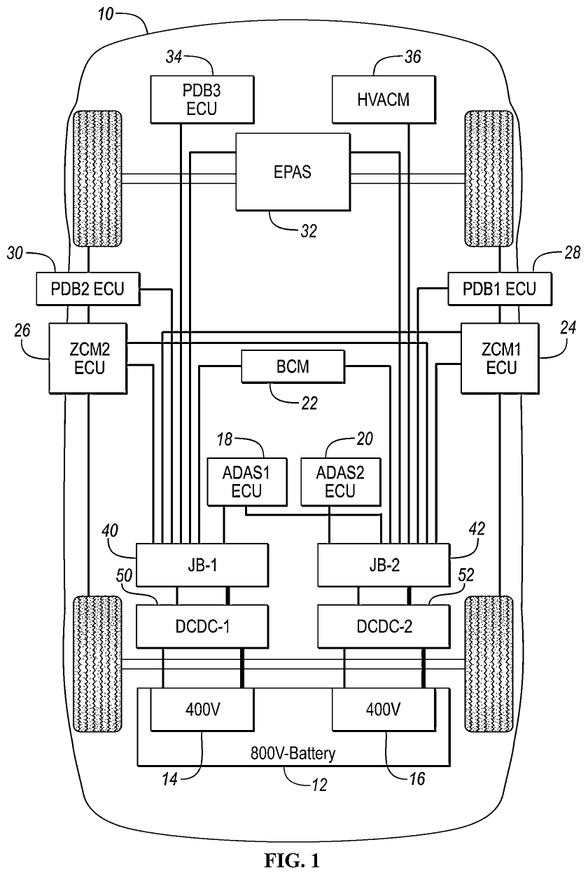

FIG. 1 is a simplified block diagram of a non-limiting, exemplary embodiment of an electric or hybrid-electric vehicle (EV/IEV) 10. As seen therein, EV/IEV 10 includes a high-voltage (HV) battery 12 (e.g., 800 volts). In that regard, HV battery 12 is a split battery that comprises a series connection of two battery strings, namely, a first HV battery (HVB-1) 14 (e.g., 400 volts) and a second HV battery (HVB-2) 16 (e.g., 400 volts). It is noted that HV generally may be any voltage greater than or equal to 48 volts. The HV battery 12 also thereby provides redundancies on electrical power supply systems for vehicle with features requiring high automotive safety integrity levels (ASIL), such as Autonomous Drive vehicles.

The EV/HEV 10 also includes a number of low-voltage (LV) electrical loads distributed around the EV/HEV 10 and powered via an LV powernet or electrical network. As seen in FIG. 1, exemplary LV loads shown include a first high-ASIL advanced driver assistance system (ADAS) electronic control unit (ECU) (ADAS-1) 18, a second high-ASIL ADAS ECU (ADAS-2) 20, a body control module (BCM) 22, a first zone control module (ZCM) ECU (ZCM-1) 24, a second ZCM ECU (ZCM-2) 26, a first power distribution box (PDB) ECU (PDB-1) 28, a second PDB ECU (PDB-2) 30, an electric power assisted steering (EPAS) module 32, a third PDB ECU (PDB-3) 34, and a heating, ventilation, air conditioning control module (HVACM) 36.

The various LV loads of the EV/IEV 10 may be connected via the LV electrical network to one or both of a first junction box (JB-1) 40 and a second junction box (JB-2) 42. As seen in FIG. 1, LV loads such as ADAS-2 20, PDB-1 28, PDB-2 30, PDB-3 34, and HVACM 36 are connected to either JB-1 40 or JB-2 42. Other LV loads such as ADAS-1 18, BCM 22, ZCM-1 24, ZCM-2 26, and EPAS 32 are connected to both JB-1 40 and JB-2 42.

Still referring to FIG. 1, JB-1 40 is connected to a first direct-current-to-direct-current (DC-to-DC) voltage converter (DCDC-1) 50, and JB-2 42 is connected to a second DC-to-DC voltage converter (DCDC-2) 52. In turn, DCDC-1 50 is connected to HVB-1 14, and DCDC-2 52 is connected to HVB-2 16. In that regard, it is noted that no 12 volt battery is included in the EV/HEV 10 for providing LV power to the LV loads 18, 20, 22, 24, 26, 28, 30, 32, 34, 36 connected to the LV electrical network. In operation, DCDC-1 50 converts the 400 volts provided by HVB-1 14 to an LV output (e.g., 12 volts) that is provided to JB-1 40 for distribution to the LV loads connected thereto. Similarly, in operation, DCDC-2 52 converts the 400 volts provided by HVB-2 16 to an LV output (e.g., 12 volts) that is provided to JB-2 42 for distribution to the LV loads connected thereto. It is noted that LV generally may be any voltage less than or equal to 24 volts. In that regard, both LV networks (i.e., those supplied by JB-1 and JB-2) share the same ground connection, and a proper 12 volt positive connection voltage matching between the two LV networks is disclosed in U.S. Patent Application Publication No. US 2023-0163683 A1 (U.S. patent application Ser. No. 17/533,314, filed on Nov. 23, 2021) entitled “Method and System for Balancing Parallel DC/DC Converters,” which is hereby incorporated by reference herein in its entirety.

The main problem with the architecture shown in FIG. 1 is the development of a power imbalance (i.e., unequal voltages) between HVB-1 14 and HVB-2 16 during operation of the EV/IEV 10. In that regard, such a power imbalance is caused by asymmetric power consumption by DCDC-1 50 and DCDC-2 52, depending on a final driving profile of a user of the EV/HEV 10 as well as the usage of the LV loads of the EV/HEV 10.

The existing strategy to address such a problem is to sense the LV outputs consumption at JB-1 40 and JB-2 42 (e.g., using one more sensors (not shown)), and attempt to minimize the energy flow differences using a load equalizer system. In that regard, balancing of the voltages of HVB-1 14 and HVB-2 16 is performed when the EV/HEV 10 is parked (i.e., not in motion) and the HV battery 12 is not in use for traction mode propulsion of the EV/HEV 10. Such passive balancing “burns” the extra energy from that battery, either HVB-1 14 or HVB-2 16, with a higher voltage.

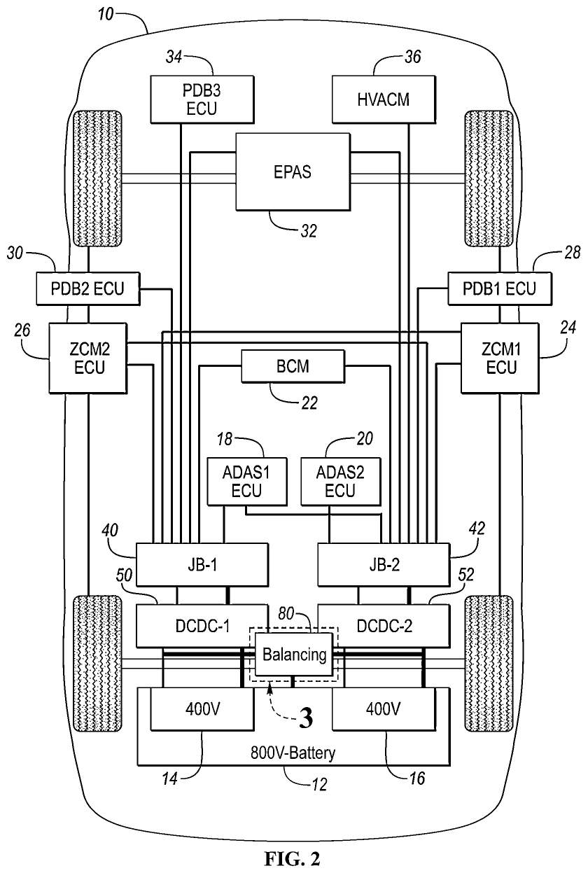

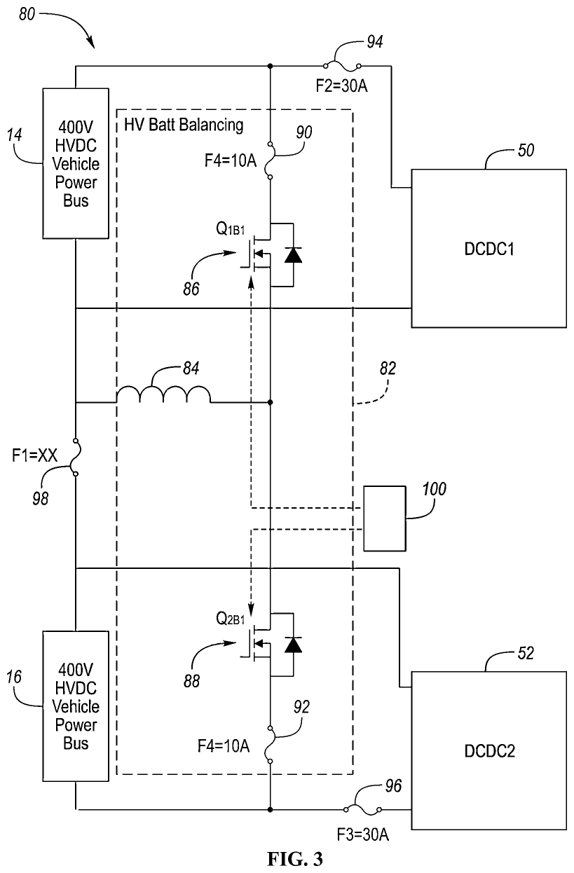

The present disclosure provides an improved battery balancing strategy to address such a problem in an EV/HEV 10. In that regard, FIG. 2 is a simplified block diagram of a non-limiting, exemplary embodiment of an electric or hybrid electric vehicle 10 equipped with a voltage balancing circuit 80 according to the present disclosure. FIG. 3 is a simplified block diagram of a non-limiting, exemplary embodiment of a voltage balancing circuit 80 according to the present disclosure.

As seen therein, the voltage balancing circuit 80 of the present disclosure comprises a buck/boost, highly efficient, DC-to-DC converter 82. The DC-to-DC converter 82 interfaces HVB-1 14 and HVB-2 16 to provide balancing of any power differences therebetween. More specifically, the DC-to-DC converter 82 comprises an inductor 84 and switches 86, 88 (e.g., transistors) connected in a buck/boost configuration. In that regard, in one exemplary implementation or embodiment, inductor 84 may be provided with a value of 100 microhenries (pH), and switches 86, 88 may each comprise a Silicon Carbide (SiC) metal-oxide semiconductor field-effect transistor (MOSFET) capable of withstanding 1200 volts (V). More particularly, switches 86, 88 may each comprise a 69 mΩ/1200V SiC MOSFET. In that regard, balancing more power is possible through selecting lower drain-source on resistance (Rdson) devices.

The buck/boost configuration of the DC-to-DC converter 82 transfers power from that HV battery, either HVB-1 14 or HVB-2 16, with a higher voltage (i.e., less discharged) than the other. As seen in FIG. 3, the DC-to-DC converter 82 is protected against failure by fuse 90 (e.g., 10 Amps) connected between DC-to-DC converter 82 and HVB-1 14, as well as by fuse 92 (e.g., 10 Amps) connected between DC-to-DC converter 82 and HVB-2 16. Additional protective fuses 94, 96 (e.g., 30 Amps) are connected between DCDC-1 50 and HVB-1 14, as well as between DCDC-2 52 and HVB-2 16. A protective fuse 98 (e.g., greater than 600 Amps) is also provided between HVB-1 14 and HVB-2 16. Utilizing the voltage balancing circuit 80 of the present disclosure enables voltage balancing to be performed even when the EV/HEV 10 is in motion and the HV battery 12 in use for traction mode propulsion of the EV/HEV 10 (i.e., real-time balancing).

Still referring to FIG. 3, a control unit or controller 100 is also provided to control the ON/OFF switching operations, including duty cycles, of switches 86, 88 via control signals generated by and transmitted from the controller 100 to thereby produce, along with the inductor 84, the buck/boost DC-to-DC voltage conversion described herein (i.e., voltage balancing). As those skilled in the art will understand, the controller 100, as well as any other component, system, subsystem, unit, module, circuit, stage, interface, sensor, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof, any component, system, subsystem, unit, module, circuit, stage, interface, sensor, device, or the like described herein, and/or for performing the particular algorithm or algorithms represented by the various methods, functions and/or operations described herein, including interaction between and/or cooperation with each other.

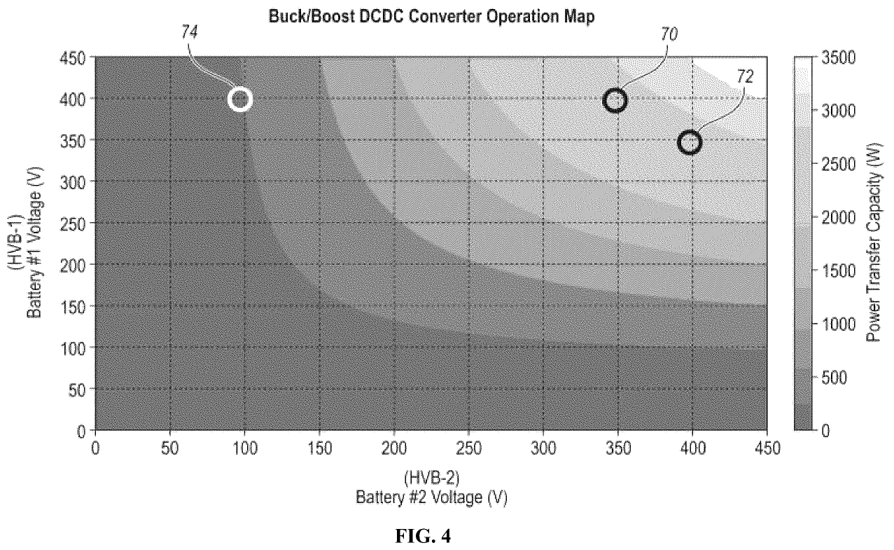

FIG. 4 is an operation map of a non-limiting, exemplary embodiment of a voltage balancing circuit according to the present disclosure. More particularly, FIG. 4 illustrates a graph of power transfer capability (measured in Watts) of the buck/boost DC-to-DC converter 82 of FIG. 3 related to voltages (measured in volts) of both HVB-1 14 and HVB-2 16. As seen in FIG. 4, and with continuing reference to FIG. 3, HVB-1 14 and HVB-2 16 may each have a voltage level of up to 450 volts. Depending on the respective voltage levels of HVB-1 14 and HVB-2 16, the voltage balancing circuit 80 of the present disclosure, including the buck/boost DC-to-DC converter 82 as described herein, provides power transfer capacity of up to 3500 Watts.

In that regard, in one example shown in FIG. 4, when HVB-1 14 has a voltage of approximately 400 volts and HVB-2 16 has a voltage of approximately 350 volts, the voltage balancing circuit 80 provides power transfer capacity 70 of approximately 2500 Watts. Similarly, in another example shown in FIG. 4, when HVB-1 14 has a voltage of approximately 350 volts and HVB-2 16 has a voltage of approximately 400 volts, the voltage balancing circuit 80 again provides power transfer capacity 72 of approximately 2500 Watts. Moreover, as also seen in FIG. 4, the voltage balancing circuit 80 of the present disclosure, including the buck/boost DC-to-DC converter 82 as described herein, provides a 500 Watt (i.e., one-half kilowatt (kW) or 0.5 kW) minimum power transfer capacity 74 for wide unbalanced battery conditions (e.g., HVB-1 14 having a voltage level of approximately 400 volts and HVB-2 16 having a voltage level of approximately 100 volts). It is also noted that, with the components selected as described herein, the voltage balancing circuit 80 of the present disclosure, including the buck/boost DC-to-DC converter 82, provides at least 97% efficiency to avoid wasting of energy when transferring from one battery to another, and that different efficiencies may be achieved with alternative component selections.

The present disclosure thus provides a solution to the power imbalance caused by asymmetric power consumption of DCDC converters utilized with string batteries as described herein. That is, the voltage balancing circuit of the present disclosure provides a solution for a modular battery architecture (e.g., 800 volts) composed of series of battery strings (e.g., 400 volts+400 volts). The voltage balancing circuit of the present disclosure is also a scalable solution applicable to multiple battery string configurations. Moreover, the voltage balancing circuit of the present disclosure provides a clustered solution that can be cross-product integrated (e.g., DC-to-DC converter (DCDC), power distribution unit (BDU), vehicle on-board battery charger (OBC)) and independent of other implemented functions, on demand. Furthermore, the voltage balancing circuit of the present disclosure results in vehicle overall higher efficiency than existing passive balancing methods.

Item 1: In one embodiment, the present disclosure provides a voltage balancing circuit comprising a direct current to direct current (DC-to-DC) voltage converter interconnecting a first battery having a first voltage and a second battery having a second voltage, wherein the DC-to-DC converter transfers electrical power from the first battery to the second battery when the first voltage is greater than the second voltage, and transfers electrical power from the second battery to the first battery when the first voltage is less than the second voltage, and wherein the transfer of electrical power from the first battery to the second battery or from the second battery to the first battery balances the electrical power difference between the first battery and the second battery.

Item 2: In another embodiment, the present disclosure provides the voltage balancing circuit according to Item 1, wherein the DC-to-DC converter transfers electrical power from the first battery to the second battery until the first voltage equals the second voltage.

Item 3: In another embodiment, the present disclosure provides the voltage balancing circuit according to any preceding Item, wherein the DC-to-DC converter transfers electrical power from the second battery to the first battery until the first voltage equals the second voltage.

Item 4: In another embodiment, the present disclosure provides the voltage balancing circuit according to any preceding Item, wherein the DC-to-DC converter comprises a buck-boost circuit comprising an inductor, a first switch, and a second switch.

Item 5: In another embodiment, the present disclosure provides the voltage balancing circuit according to Item 4 further comprising a controller that controls operation of the first switch and the second switch of the buck-boost circuit based on the first voltage and the second voltage.

Item 6: In another embodiment, the present disclosure provides the voltage balancing circuit according to any preceding Item, wherein the DC-to-DC converter provides a minimum power transfer of one-half kilowatt in the event of an unbalanced condition between the first battery and the second battery

Item 7: In another embodiment, the present disclosure provides the voltage balancing circuit according to any preceding Item, further comprising a first fuse connected between the first battery and the DC-to-DC converter, and a second fuse connected between the second battery and the DC-to-DC converter.

Item 8: In another embodiment, the present disclosure provides the voltage balancing circuit according to any preceding Item, wherein the first battery and the second battery are connected in series to form a split battery for an electric vehicle.

Item 9: In another embodiment, the present disclosure provides a vehicle comprising the voltage balancing circuit according to any preceding Item.

Item 10: In another embodiment, the present disclosure provides the vehicle of Item 9 wherein the voltage balancing circuit operates while the vehicle is in motion.

Item 11: In another embodiment, the present disclosure provides a non-transitory computer readable storage medium having stored computer executable instructions for controlling a voltage balancing circuit comprising a direct current to direct current (DC-to-DC) voltage converter interconnecting a first battery having a first voltage and a second battery having a second voltage. Execution of the computer executable instructions causes the DC-to-DC voltage converter to transfer electrical power from the first battery to the second battery when the first voltage is greater than the second voltage, and transfer electrical power from the second battery to the first battery when the first voltage is less than the second voltage, wherein the transfer of electrical power from the first battery to the second battery or from the second battery to the first battery balances the electrical power difference between the first battery and the second battery.

Item 12: In another embodiment, the present disclosure provides the non-transitory computer readable storage medium of Item 11 wherein execution of the computer executable instructions causes the DC-to-DC converter to transfer electrical power from the first battery to the second battery until the first voltage equals the second voltage.

Item 13: In another embodiment, the present disclosure provides the non-transitory computer readable storage medium according to any preceding Item, wherein execution of the computer executable instructions causes the DC-to-DC converter to transfer electrical power from the second battery to the first battery until the first voltage equals the second voltage.

Item 14: In another embodiment, the present disclosure provides the non-transitory computer readable storage medium according to any preceding Item, wherein the DC-to-DC converter of the voltage balancing circuit comprises a buck-boost circuit comprising an inductor, a first switch, and a second switch.

Item 15: In another embodiment, the present disclosure provides the non-transitory computer readable storage medium according to Item 14, wherein the voltage balancing circuit further comprises a controller, and wherein execution of the computer executable instructions causes the controller to control operation of the first switch and the second switch of the buck-boost circuit based on the first voltage and the second voltage.

Item 16: In another embodiment, the present disclosure provides the non-transitory computer readable storage medium according to any preceding Item, wherein operation of the voltage balancing circuit according to execution of the computer executable instructions causes the DC-to-DC converter to provide a minimum power transfer of one-half kilowatt in the event of an unbalanced condition between the first battery and the second battery.

Item 17: In another embodiment, the present disclosure provides the non-transitory computer readable storage medium according to any preceding Item, wherein the voltage balancing circuit further comprises a first fuse connected between the first battery and the DC-to-DC converter, and a second fuse connected between the second battery and the DC-to-DC converter.

Item 18: In another embodiment, the present disclosure provides the non-transitory computer readable storage medium according to any preceding Item, wherein the first battery and the second battery are connected in series to form a split battery for an electric vehicle.

Item 19: In another embodiment, the present disclosure provides a vehicle comprising the non-transitory computer readable storage medium according to any preceding Item.

Item 20: In another embodiment, the present disclosure provides the vehicle of Item 19 wherein the voltage balancing circuit operates according the computer executable instructions while the vehicle is in motion.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, unless the context clearly indicates otherwise, the various features, elements, components, methods, procedures, steps, and/or functions of various implementing embodiments may be combined or utilized in any combination or combinations and/or may be performed in any order other than those specifically described herein to form further embodiments according to the present disclosure.

1. A voltage balancing circuit comprising:
a direct current to direct current (DC-to-DC) voltage converter interconnecting a first battery having a first voltage and a second battery having a second voltage;
wherein the DC-to-DC converter transfers electrical power from the first battery to the second battery when the first voltage is greater than the second voltage, and transfers electrical power from the second battery to the first battery when the first voltage is less than the second voltage;
wherein the transfer of electrical power from the first battery to the second battery or from the second battery to the first battery balances the electrical power difference between the first battery and the second battery.

2. The voltage balancing circuit according to claim 1, wherein the DC-to-DC converter transfers electrical power from the first battery to the second battery until the first voltage equals the second voltage.

3. The voltage balancing circuit according to claim 1, wherein the DC-to-DC converter transfers electrical power from the second battery to the first battery until the first voltage equals the second voltage.

4. The voltage balancing circuit according to claim 1, wherein the DC-to-DC converter comprises a buck-boost circuit comprising an inductor, a first switch, and a second switch.

5. The voltage balancing circuit according to claim 4 further comprising a controller that controls operation of the first switch and the second switch of the buck-boost circuit based on the first voltage and the second voltage.

6. The voltage balancing circuit according to claim 1, wherein the DC-to-DC converter provides a minimum power transfer of one-half kilowatt in the event of an unbalanced condition between the first battery and the second battery.

7. The voltage balancing circuit according to claim 1, further comprising a first fuse connected between the first battery and the DC-to-DC converter, and a second fuse connected between the second battery and the DC-to-DC converter.

8. The voltage balancing circuit according to claim 1, wherein the first battery and the second battery are connected in series to form a split battery for an electric vehicle.

9. A vehicle comprising the voltage balancing circuit according to claim 1.

10. The vehicle of claim 9 wherein the voltage balancing circuit operates while the vehicle is in motion.

11. A non-transitory computer readable storage medium having stored computer executable instructions for controlling a voltage balancing circuit comprising a direct current to direct current (DC-to-DC) voltage converter interconnecting a first battery having a first voltage and a second battery having a second voltage, wherein execution of the computer executable instructions causes the DC-to-DC voltage converter to:
transfer electrical power from the first battery to the second battery when the first voltage is greater than the second voltage; and
transfer electrical power from the second battery to the first battery when the first voltage is less than the second voltage;
wherein the transfer of electrical power from the first battery to the second battery or from the second battery to the first battery balances the electrical power difference between the first battery and the second battery.

12. The non-transitory computer readable storage medium of claim 11 wherein execution of the computer executable instructions causes the DC-to-DC converter to transfer electrical power from the first battery to the second battery until the first voltage equals the second voltage.

13. The non-transitory computer readable storage medium according to claim 11, wherein execution of the computer executable instructions causes the DC-to-DC converter to transfer electrical power from the second battery to the first battery until the first voltage equals the second voltage.

14. The non-transitory computer readable storage medium according to claim 11, wherein the DC-to-DC converter of the voltage balancing circuit comprises a buck-boost circuit comprising an inductor, a first switch, and a second switch.

15. The non-transitory computer readable storage medium according to claim 14, wherein the voltage balancing circuit further comprises a controller, and wherein execution of the computer executable instructions causes the controller to control operation of the first switch and the second switch of the buck-boost circuit based on the first voltage and the second voltage.

16. The non-transitory computer readable storage medium according to claim 11, wherein operation of the voltage balancing circuit according to execution of the computer executable instructions causes the DC-to-DC converter to provide a minimum power transfer of one-half kilowatt in the event of an unbalanced condition between the first battery and the second battery.

17. The non-transitory computer readable storage medium according to claim 11, wherein the voltage balancing circuit further comprises a first fuse connected between the first battery and the DC-to-DC converter, and a second fuse connected between the second battery and the DC-to-DC converter.

18. The non-transitory computer readable storage medium according to claim 11, wherein the first battery and the second battery are connected in series to form a split battery for an electric vehicle.

19. A vehicle comprising the non-transitory computer readable storage medium according to claim 11.

20. The vehicle of claim 19 wherein the voltage balancing circuit operates according to the computer executable instructions while the vehicle is in motion.
